(19) United States
(12) Patent Application Publication
(10) Pub. No.: US 2024/0303090 A1
(43) Pub. Date: Sep. 12, 2024

(54) DATA PROCESSING METHOD AND DATA PROCESSING ACCELERATOR SYSTEM

(71) Applicant: Alibaba (China) Co., Ltd., Hangzhou (CN)

(72) Inventors: Shijian Zhang, Beijing (CN); Lide Duan, Sunnyvale, CA (US); Hongzhong Zheng, Shanghai (CN)

(21) Appl. No.: 18/598,423

(22) Filed: Mar. 7, 2024

(30) Foreign Application Priority Data
Mar. 8, 2023 (CN) 202310242886.X

(51) Int. Cl. G06F 9/445

(52) U.S. Cl. CPC G06F 9/44505

(57) ABSTRACT

A data processing method, applicable to an accelerator that is communicatively coupled to a processor core, includes obtaining a service data processing request from a first queue; obtaining to-be-processed service data corresponding to the service data processing request from the processor core via a service interface; generating result service data based on the to-be-processed service data; and writing the result service data into a second queue for providing to the processor core.

### CROSS-REFERENCE TO RELATED APPLICATIONS

The disclosure claims the benefits of priority to Chinese Application No. 202310242886.X, filed Mar. 8, 2023, which is incorporated herein by reference in its entirety.

### TECHNICAL FIELD

The present disclosure generally relates to video processing, and more particularly, to a data processing method and a data processing accelerator system.

### BACKGROUND

In high-performance computing, a central processing unit (CPU) core is configured to perform general-purpose computing, and a domain specific accelerator (DSA) is configured to perform hardware acceleration. Data interaction between the processor core and the DSA may be performed through signal interface-based interaction and queue-based interaction. The signal interface-based interaction requires addition of many interface signals and requires large changes to the CPU core. The queue-based interaction requires minor changes to the CPU core but does not support heterogeneous instructions. Therefore, a new interaction manner between the CPU core and the DSA is urgently required, to resolve the above technical problem.

### SUMMARY OF THE DISCLOSURE

Embodiments of the present disclosure provide a data processing method, applicable to an accelerator that is communicatively coupled to a processor core. The method includes obtaining a service data processing request from a first queue; obtaining to-be-processed service data corresponding to the service data processing request from the processor core via a service interface; generating result service data based on the to-be-processed service data; and writing the result service data into a second queue for providing to the processor core.

Embodiments of the present disclosure provide a data processing method, applicable to a processor core that is communicatively coupled to an accelerator. The method includes writing a service data processing request into a first queue by the accelerator; and reading result service data from a second queue, wherein the result service data is generated based on to-be-processed service data.

Embodiments of the present disclosure provide a system. The system includes a processor core configured to write a service data processing request into a first queue; and an accelerator communicatively coupled to the processor core, configured to obtain the service data processing request from the first queue; obtain to-be-processed service data corresponding to the service data processing request from the processor core via a service interface; generate result service data based on the to-be-processed service data; and write the result service data into a second queue for providing to the processor core; wherein the processor core is further configured to read the result service data from the second queue.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic structural diagram of a data processing method, according to some embodiments of the present disclosure.

FIG. 2 is a flowchart of a data processing method applicable to an accelerator, according to some embodiments of the present disclosure.

FIG. 3 is a schematic diagram of data transfer in an accelerator, according to some embodiments of the present disclosure.

FIG. 4 is a flowchart of a data processing method applicable to a processor core, according to some embodiments of the present disclosure.

FIG. 5 is a schematic diagram of data transfer in a processor core, according to some embodiments of the present disclosure.

FIG. 6 is an interaction flowchart of a data processing method applicable to a data processing system, according to some embodiments of the present disclosure.

FIG. 7 is a schematic structural diagram of a data processing accelerator system applicable to an accelerator, according to some embodiments of the present disclosure.

FIG. 8 is a schematic structural diagram of a data processing accelerator system applicable to a processor core, according to some embodiments of the present disclosure.

FIG. 9 is a structural block diagram of a computing device, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

It should be noted that, user information (including but not limited to user device information and user personal information) and data (including but not limited to data for analysis, stored data, and displayed data) in the present disclosure are all information and data authorized by a user or fully authorized by all parties, and collection, use, and processing of relevant data need to comply with relevant laws, regulations, and standards of relevant countries and regions. Corresponding operation entries are provided for the user to select authorization or rejection.

The present disclosure provides a data processing method. The present disclosure further relates to a data processing accelerator system, a computing device, and a computer-readable storage medium, which are described in detail one by one in the following embodiments.

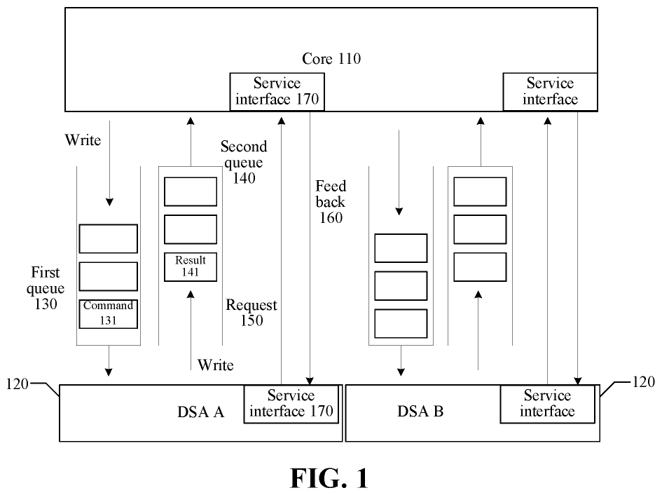

FIG. 1 is a schematic structural diagram illustrating a data processing method, according to some embodiments of the present disclosure. The data processing method provided in the present disclosure is applicable to a data processing system. The data processing system includes a processor core 110 and at least one hardware accelerator 120 (e.g., domain specific accelerator, DSA, which is a hardware computing engine that is specialized for a particular domain of applications). Two DSAs (e.g., DSA A and DSA B) are shown in FIG. 1 for illustrative purposes. Each DSA (e.g., DSA A and DSA B) is connected to the core 110. Core 110 is a core of a processor. DSA is an accelerator with extended functions oriented toward some fields based on general processing, to improve problem resolving efficiency in the fields.

In a practical application, the processor core 110 writes a command 131 into a first queue 130, and the accelerator (e.g., DSA 121) reads the command 131 from the first queue 130 and generates a corresponding processing result 141. Through the form of the queue (e.g., first queue 130), the accelerator 120 and the processor core 110 may be in different clock domains, that is, the processor core 110 and the accelerator 120 do not need to maintain synchronization during task processing.

In a process in which the accelerator 120 reads the command (e.g., command 131) from the first queue 130 and executes the command (e.g., command 131), if data required for executing the command (e.g., command 131) exists locally in the accelerator 120, the data may be directly read and a corresponding operation may be performed. If the data required for executing the command does not exist locally in the accelerator 120, a data obtaining request 150 needs to be transmitted to the processor core 110 through a service interface 170.

After the processor core 110 receives the data obtaining request 150, the data required for executing the command (e.g., command 131) is obtained locally from the processor core 110, and the data (e.g., a feedback 160) is transmitted to the accelerator 120 through the service interface 170, so that the accelerator 120 may perform a corresponding operation based on the data (e.g., feedback 160). Through transmission of data obtaining information and service data through the service interface 170, heterogeneous instructions can be executed as a result of queue-based interaction, and more data interaction is realized.

After executing the command (e.g., command 131), the accelerator 120 obtains the corresponding processing result 141 and writes the processing result 141 into a second queue 140. The processor core 110 may read the processing result 141 from the second queue 140 and perform corresponding processing in the processor core 110.

According to the data processing method provided in this example of the present disclosure, the processor core 110 transmits the command (e.g., command 131) to the accelerator 120 based on the first queue 130, and the accelerator 120 obtains the command (e.g., command 131) from the first queue 130, executes the command (e.g., command 131), and transmits the execution result (e.g., result 141) to the processor core 110 based on the second queue 140. Through the queues (e.g., first queue 130 and second queue 140), the processor core 110 and the accelerator 120 may be in different clock domains, which improves data processing efficiency, and the processor core 110 and the accelerator 120 may perform the corresponding operations asynchronously. In addition, when the accelerator 120 lacks data, the accelerator 120 may transmit the data obtaining request 150 to the processor core 110 in a timely manner through a service interface 170, supporting heterogeneous instructions and avoiding a data processing failure of the accelerator caused by the lack of data through only a small amount of modification, which improves data processing accuracy and efficiency.

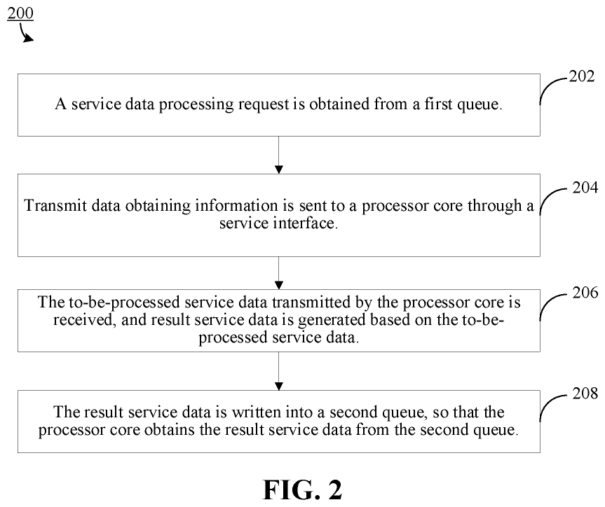

FIG. 2 is a flowchart of a data processing method 200, according to some embodiments of the present disclosure. The data processing method 200 is applicable to an accelerator (e.g., accelerator 120 shown in FIG. 1). Referring to FIG. 1 and FIG. 2, the method 200 specifically includes the steps 202 to 208.

At step 202, a service data processing request is obtained from a first queue.

The first queue (e.g., first queue 130) is specifically a queue configured to store the service data processing request. The service data processing request (e.g., command 131) is transmitted from a processor core 110. In a practical application, the service data processing request (e.g., command 131) is triggered by the processor core 110. To improve the data processing speed, the service data processing request (e.g., command 131) is transmitted to the accelerator 120, and the accelerator 120 specially performs a corresponding operation on service data. To improve the respective processing speeds of the processor core and the accelerator, the processor core writes the service data processing request into the queue in a form of a queue, and then the accelerator pulls the service processing request from the first queue. Through the arrangement of the queue, the processor core and the accelerator may be in different clock domains, which improves the data processing efficiency.

At step 204, transmit data obtaining information is sent to a processor core through a service interface. The data obtaining information is used for requesting to-be-processed service data corresponding to the service data processing request from the processor core.

The service interface (e.g., service interface 170) is specifically an interface arranged in the accelerator 120 and the processor core 110 for data and instruction transmission. When the accelerator 120 needs some necessary states and service data in the processor core 110, the accelerator 120 may perform corresponding transmission through the service interface 170.

The data obtaining information (e.g., data obtaining request 150) herein is specifically information to be transmitted to the processor core 110 to obtain information about the to-be-processed service data corresponding to the service data processing request (e.g., command 131). In a practical application, the data in the processor core 110 is transmitted to the accelerator 120 and is stored in a register of the accelerator 120 for acceleration of data processing. However, the register may sometimes be in an invalid state. In this case, the data in the register cannot be used. When the service data processing request (e.g., command 131) hits the invalid register, the corresponding to-be-processed service data cannot be obtained, which causes a failure to the service data processing request (e.g., command 131) on the accelerator side.

Based on the above, in some embodiments, the data obtaining information (e.g., request 150) does not always need to be transmitted to the processor core 110 for the service data processing request (e.g., command 131). The data obtaining information (e.g., request 150) is transmitted to the processor core 110 based on the service interface 170 only when it is determined that the to-be-processed service data corresponding to the service data processing request (e.g., command 131) does not exist in the accelerator 120.

Specifically, in some embodiments, the transmitting data obtaining information to a processor core through a service interface includes: determining whether the to-be-processed service data corresponding to the service data processing request exists in the accelerator; if the to-be-processed service data corresponding to the service data processing request exists in the accelerator, reading the to-be-processed service data; and if the to-be-processed service data corresponding to the service data processing request does not exist in the accelerator, generating the data obtaining information and transmitting the data obtaining information to the processor core through the service interface.

In a practical application, after the service data processing request is obtained, it is determined locally in the accelerator whether the to-be-processed service data corresponding to the service data processing request is stored in the accelerator.

When the to-be-processed service data is stored in the accelerator, the to-be-processed service data may be directly read, and a corresponding operation may be performed on the to-be-processed service data based on the service data processing request, to obtain the result service data (e.g., result 141).

When the to-be-processed service data does not exist in the accelerator, the corresponding data obtaining information needs to be generated, and is transmitted to the processor core based on the service interface between the accelerator and the processor core.

In some embodiments, a physical register file is a physical register that stores register data. For example, an accelerator register file is a register that stores register data of the accelerator, and a core register file is a register that stores register data of the core. In some embodiments, the determining whether the to-be-processed service data corresponding to the service data processing request exists in the accelerator includes: reading a register identifier in the service data processing request; searching an accelerator register file of the accelerator for a target register corresponding to the register identifier; determining that the to-be-processed service data corresponding to the service data processing request exists when a register status of the target register is valid; and determining that the to-be-processed service data corresponding to the service data processing request does not exist when the register status of the target register is invalid.

The service data processing request carries the register identifier. The service data processing request specifically means processing the to-be-processed service data in the register identifier. Therefore, the accelerator needs to be searched based on the register identifier to find the to-be-processed service data.

After the register identifier in the service data processing request is obtained, the accelerator register file may be searched for the target register corresponding to the register identifier. The accelerator register file is specifically a register file stored locally in the accelerator.

After the target register is obtained, the register status of the target register needs to be obtained. When the register status is valid, it indicates that the to-be-processed service data corresponding to the service data processing request may be obtained from the target register. When the register status is invalid, it indicates that the to-be-processed service data corresponding to the service data processing request cannot be obtained from the target register in this case, and therefore the result service data cannot be further generated based on the to-be-processed service data.

When the to-be-processed service data stored in the target register cannot be obtained, the corresponding to-be-processed service data needs to be obtained from the processor core. In this case, the generating the data obtaining information includes: writing a register identifier in the service data processing request into an invalid register queue; reading the register identifier from the invalid register queue; and generating the data obtaining information based on the register identifier.

Specifically, an invalid register queue is arranged in the accelerator. The invalid register queue is configured to store a register identifier corresponding to a register in an invalid state. When it is determined that the target register corresponding to the register identifier is in an invalid state, the register identifier may be written into the invalid register queue.

The service interface periodically reads the invalid register queue, obtains a register identifier stored in the invalid register queue, generates data obtaining information based on the register identifier, and transmits the data obtaining information to the processor core through the service interface.

At step 206, the to-be-processed service data transmitted by the processor core is received, and result service data is generated based on the to-be-processed service data.

The processor core 110 performs searching based on the data obtaining information (e.g., data obtaining request 150) for the corresponding to-be-processed service data and returns the to-be-processed service data (e.g., feedback 160) to the accelerator 120 through the service interface 170. Then the accelerator 120 may receive the to-be-processed service data transmitted by the processor core 110. The accelerator 120 performs corresponding processing on to-be-processed service data based on the service data processing request (e.g., command 131), to obtain the result service data (e.g., result 141) corresponding to the to-be-processed service data.

Specifically, step 206 that receiving the to-be-processed service data transmitted by the processor core, and generating result service data based on the to-be-processed service data includes: receiving the to-be-processed service data transmitted by the processor core, and updating the accelerator register file based on the register identifier and the to-be-processed service data; and reading the to-be-processed service data from the accelerator register file based on the register identifier, and generating the result service data based on the to-be-processed service data.

In a practical application, after receiving the to-be-processed service data transmitted by the processor core, the accelerator updates the target register in the accelerator register file based on the register identifier and the to-be-processed service data. The to-be-processed service data transmitted by the processor core further includes the register identifier.

During the processing of the to-be-processed service data, the accelerator needs to search the accelerator register file again based on the register identifier for the corresponding target register and read the to-be-processed service data from the target register. Then the accelerator processes the to-be-processed service data based on the service data processing request again, to obtain the corresponding result service data.

It should be noted that, to further improve the data processing speed in the accelerator, the register status of the target register may alternatively be updated based on to-be-processed data ready information pre-returned by the processor core.

Specifically, in some embodiments, before the receiving the to-be-processed service data transmitted by the processor core, the method further includes: receiving data ready information transmitted by the processor core, and updating the register status of the target register to valid based on the data ready information.

The data ready information is information transmitted by the processor core. A transmission time of the data ready information is earlier than a transmission time of the to-be-processed service data. While searching by the processor core for the to-be-processed service data, the data ready information is pre-generated, and is pre-returned to the accelerator. After receiving the data ready information, the accelerator may learn that the to-be-processed data of the target register will be transmitted later. Therefore, the accelerator may pre-update the register status of the target register to valid. After the to-be-processed service data arrives at the accelerator, the accelerator may directly read the to-be-processed service data based on the register status of the target register, thereby performing corresponding processing on the to-be-processed service data and obtaining the result service data more quickly. This improves the data processing speed in the accelerator.

At step 208, the result service data is written into a second queue, so that the processor core obtains the result service data from the second queue.

After the result service data (e.g., result 141) is obtained through calculation in the accelerator 120, the accelerator 120 may write the result service data (e.g., result 141) into the second queue 140. The second queue 140 is specifically a queue configured to store the result service data generated by the accelerator in response to the service data processing request (e.g., command 131). The processor core 110 may read the result service data (e.g., result 141) from the second queue 140 at any time based on an actual situation.

Some embodiments of the present disclosure provide a data processing method. The method is applicable to the accelerator, and includes: obtaining the service data processing request from the first queue; transmitting data obtaining information to the processor core through the service interface, where the data obtaining information is used for requesting the to-be-processed service data corresponding to the service data processing request from the processor core; receiving the to-be-processed service data transmitted by the processor core, and generating the result service data based on the to-be-processed service data; and writing the result service data into the second queue, so that the processor core obtains the result service data from the second queue. According to the method provided, the accelerator may perform corresponding processing based on the request in the first queue without a need to keep synchronization with the processor core and may further transmit the request to the processor core to obtain data through the service interface, supporting heterogeneous instructions and only requiring minor changes.

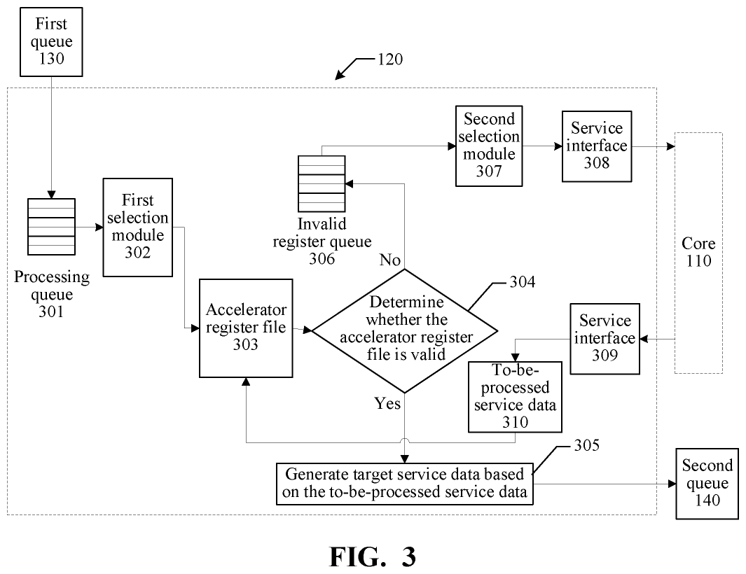

FIG. 3 is a schematic diagram of data transfer in an accelerator, according to some embodiments of the present disclosure.

A processing queue 301 exists in the accelerator. The processing queue 301 pulls a service data processing request from a first queue 130. A process queue, also referred to as an issue queue, is an instruction transmission queue in a DSA. Further, a register identifier in the service data processing request is written into the processing queue 301.

Then a first selection module 302 obtains the register identifier from the processing queue 301, searches an accelerator register file 303 in the accelerator based on the register identifier for a corresponding target register, and determines whether the target register is valid 304.

If the target register is valid, the first selection module 302 may read to-be-processed service data stored in the target register, and generate result service data based on the to-be-processed service data 305. The first selection module 302 stores the result service data into a second queue 140, for a processor core 110 to read the result service data from the second queue 140.

If the target register is invalid, it indicates that the to-be-processed service data cannot be obtained, and the register identifier needs to be stored into an invalid register queue 306. A second selection module 307 obtains the register identifier from the invalid register queue 306, generates data obtaining information, and transmits the data obtaining information to the processor core through a service interface 308.

During obtaining of the to-be-processed service data based on the register identifier, the processor core 110 first returns data ready information through the service interface. In the accelerator, a register status of the target register in the accelerator register file may be updated based on the data ready information. The register status of the target register is updated from invalid to valid. In addition, the register identifier is placed into the processing queue again, and waits for being selected and processed.

Subsequently, the processor core 110 returns the to-be-processed service data 310 through the service interface 309. The accelerator updates the target register in the accelerator register file based on the to-be-processed service data 310, and stores the to-be-processed service data 310 into the target register. The first selection module 302 reads the register identifier again from the processing queue 301, and obtains the target register corresponding to the register identifier from the accelerator register file. When the target register is valid, the first selection module 302 reads the to-be-processed service data 310 stored in the target register, and generates the result service data based on the to-be-processed service data 305, and finally writes the result service data into the second queue 140.

Some embodiments of the present disclosure provide a data processing method. The method is applicable to the accelerator, and includes: obtaining the service data processing request from the first queue; transmitting the data obtaining information to the processor core through the service interface, where the data obtaining information is used for requesting the to-be-processed service data corresponding to the service data processing request from the processor core; receiving the to-be-processed service data transmitted by the processor core, and generating the result service data based on the to-be-processed service data; and writing the result service data into the second queue, so that the processor core obtains the result service data from the second queue. According to the method provided according to some embodiments of the present disclosure, the accelerator may perform corresponding processing based on the request in the first queue without a need to keep synchronization with the processor core, and may further transmit the request to the processor core to obtain data through the service interface, supporting heterogeneous instructions and only requiring minor changes.

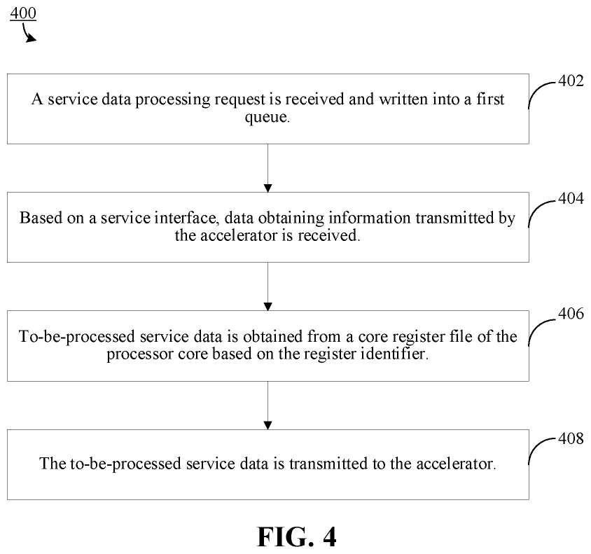

FIG. 4 is a flowchart of a data processing method 400, according to some embodiments of the present disclosure. The data processing method 400 is applicable to a processor core (e.g., a processor core 110 shown in FIG. 1). Referring to FIG. 1 and FIG. 4, the method 400 specifically includes the steps 402 to 408.

At step 402, a service data processing request is received and written into a first queue, so that an accelerator obtains the service data processing request from the first queue.

The service data processing request (e.g., command 131) is specifically a request for processing to-be-processed service data, which may be transmitted by a user or triggered by another service logic. The user or the another service logic could be also referred to an upper-level service logic layer. A manner of obtaining the service data processing request is not limited in this implementation provided in this specification.

After the service data processing request (e.g., command 131) is received, the service data processing request (e.g., command 131) needs to be processed. Further, to improve a data processing speed, the service data processing request (e.g., command 131) needs to be transmitted to the accelerator 120. The accelerator performs corresponding calculation and processing on the to-be-processed service data. Therefore, the service data processing request (e.g., command 131) may be written into the first queue 130, so that the accelerator 120 may obtain the service data processing request (e.g., command 131) from the first queue 130.

At step 404, based on a service interface, data obtaining information transmitted by the accelerator is received. The data obtaining information carries a register identifier.

As described in the above embodiment of the accelerator, when the to-be-processed service data is not stored in the accelerator 120, the accelerator 120 transmits the data obtaining information (e.g., request 150) to the processor core 110 based on the service interface 170. In this case, the processor core 110 receives the data obtaining information (e.g., request 150) transmitted by the accelerator 120 based on the service interface 170. Further, the data obtaining information (e.g., request 150) carries the register identifier. The register identifier is used for searching the processor core 110 for the corresponding to-be-processed service data.

At step 406, to-be-processed service data is obtained from a core register file of the processor core based on the register identifier.

After the data obtaining information (e.g., request 150) is received, the corresponding to-be-processed service data may be obtained from the core register file based on the register identifier carried in the data obtaining information (e.g., request 150). The core register file is specifically a file stored in the processor core 110, which is specifically an actual physical address in the processor core 110. The to-be-processed service data corresponding to the register identifier is stored at the physical address.

In a practical application, the to-be-processed service data is stored in a physical register in the processor core 110, and the physical register where the to-be-processed service data is stored cannot be directly found through the register identifier. Based on the above, the obtaining to-be-processed service data from a core register file of the processor core based on the register identifier includes: searching a register comparison table for register location information corresponding to the register identifier; and searching the core register file based on the register location information for the to-be-processed service data corresponding to the register identifier.

The register comparison table is specifically a mapping table used for storing a renaming relationship between an architecture register and a physical register. The register comparison table is also referred to as a CMap, which is a register commit map in the core and stores a renaming relationship between an architecture register and a physical register. In the register commit map, a correspondence between the register identifier and a physical location of the register is stored. The register location information corresponding to the register identifier may be found by searching the register comparison table based on the register identifier.

When the register location information is found through searching, the to-be-processed service data corresponding to the register identifier may be obtained from the physical register of the processor core based on the register location information.

Further, to improve a data processing speed for the to-be-processed data, data ready information may be generated while the register location information is found through searching, and the data ready information is transmitted to the accelerator.

In some embodiments, before the obtaining to-be-processed service data from a core register file of the processor core based on the register identifier, the method further includes: generating data ready information based on the register identifier; and transmitting the data ready information to the accelerator.

In the processor core, after the corresponding register location information is obtained by searching the register comparison table based on the register identifier, and before the to-be-processed service data is obtained from the register location information, the processor core further generates the corresponding data ready information based on the register identifier, and transmits the data ready information to the accelerator through the service interface, so that the accelerator may update a status of a register stored in the accelerator based on the data ready information.

At step 408, the to-be-processed service data is transmitted to the accelerator.

After the to-be-processed service data is obtained, the to-be-processed service data (e.g., feedback 160) may be transmitted to the accelerator 120 through the service data interface 170, so that the accelerator 120 performs corresponding processing based on the to-be-processed service data (e.g., feedback 160), thereby obtaining result service data (e.g., result 141).

In some embodiments, the method 400 further includes: reading result service data from a second queue, wherein the result service data is generated based on the to-be-processed service data; and updating the core register file based on the result service data and the register identifier.

In some embodiments, the processor core reads, based on a preset time interval, the result service data written by the accelerator from the second queue. The result service data is generated by the accelerator based on the to-be-processed service data.

After the result service data is obtained, the core register file may be updated based on the result service data and the corresponding register identifier. The data in the physical register of the processor core is updated to the result service data. In this way, the service data processing request of the upper-level service logic layer is completed.

Some embodiments of the present disclosure provide a data processing method. The method is applicable to the processor core, and includes: receiving the service data processing request, and writing the service data processing request into the first queue, so that the accelerator obtains the service data processing request from the first queue; receiving, based on the service interface, the data obtaining information transmitted by the accelerator, where the data obtaining information carries the register identifier; obtaining the to-be-processed service data from the core register file of the processor core based on the register identifier; and transmitting the to-be-processed service data to the accelerator. According to the method provided, the accelerator may perform corresponding processing based on the request in the first queue without a need to keep synchronization with the processor core and may further transmit the request to the processor core to obtain data through the service interface, supporting heterogeneous instructions and only requiring minor changes.

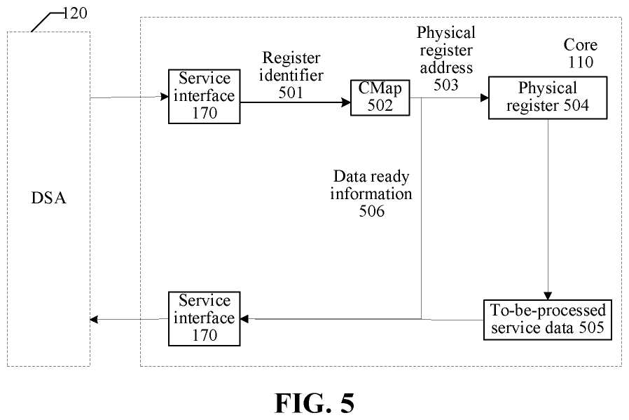

FIG. 5 is a schematic diagram of data transfer in a processor core 110, according to some embodiments of the present disclosure.

In the processor core, a service data processing request transmitted by an upper-level service logic layer is received first. To improve a data processing speed, the processor core 110 writes the service data processing request into a first queue, so that an accelerator obtains the service data processing request from the first queue.

When to-be-processed service data corresponding to the service data processing request does not exist in the accelerator, the accelerator transmits data obtaining information to the processor core based on a service interface. The data obtaining information carries a register identifier 501.

The processor core 110 searches a CMap 502 based on the register identifier 501 for a physical register address 503 of a physical register 504 corresponding to the register identifier 501, reads stored to-be-processed service data 505 from the physical register 504 of the processor core 110 based on the physical register address 503, and returns the to-be-processed service data 505 to the accelerator 120 through the service interface 170, so that the accelerator 120 performs subsequent processing and operation.

In a practical application, after the physical register address 503 is obtained by searching the CMap 502 based on the register identifier 501, data ready information 506 may be generated, and may be returned to the accelerator 120 through the service interface 170 before the to-be-processed service data 505 is transmitted, so that the accelerator 120 updates a status of a target register in the accelerator 120 corresponding to the register identifier 501 based on the data ready information 506, and adds the register identifier 501 to a processing queue. The register identifier 501 waits to be selected and processed again.

Some embodiments of the present disclosure provide a data processing method. The method is applicable to the processor core, and includes: receiving the service data processing request, and writing the service data processing request into the first queue, so that the accelerator obtains the service data processing request from the first queue; receiving, based on the service interface, the data obtaining information transmitted by the accelerator, where the data obtaining information carries the register identifier; obtaining the to-be-processed service data from a core register file of the processor core based on the register identifier; and transmitting the to-be-processed service data to the accelerator. According to the method provided in this embodiment of this specification, the accelerator may perform corresponding processing based on the request in the first queue without a need to keep synchronization with the processor core, and may further transmit the request to the processor core to obtain data through the service interface, supporting heterogeneous instructions and only requiring minor changes.

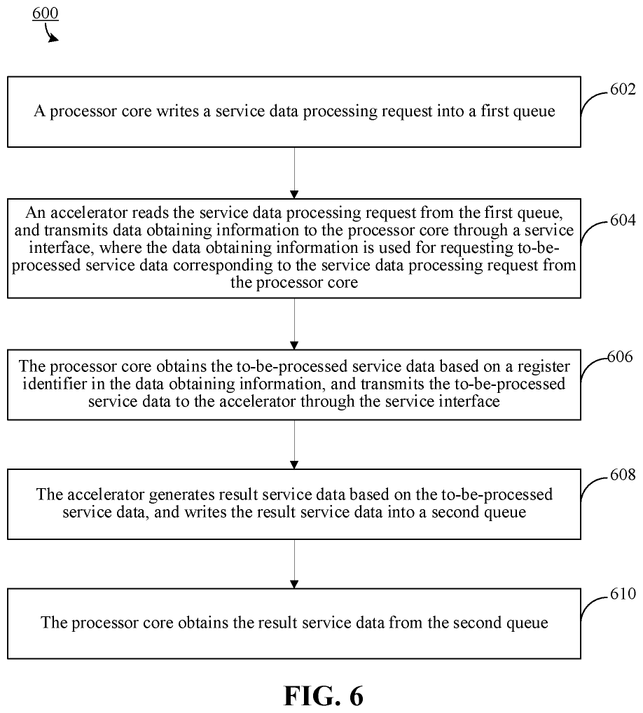

A data processing method provided in this specification is further described below with reference to FIG. 6. FIG. 6 is an interaction flowchart of a data processing method 600 applicable to a data processing system, according to some embodiments of the present disclosure. The data processing system includes a processor core (e.g., processor core 110 shown in FIG. 1) and an accelerator (e.g., accelerator 120 shown in FIG. 1). The method includes the steps 602 to 610.

At step 602, a processor core writes a service data processing request into a first queue.

At step 604, an accelerator reads the service data processing request from the first queue, and transmits data obtaining information to the processor core through a service interface, where the data obtaining information is used for requesting to-be-processed service data corresponding to the service data processing request from the processor core.

At step 606, the processor core obtains the to-be-processed service data based on a register identifier in the data obtaining information and transmits the to-be-processed service data to the accelerator through the service interface.

At step 608, the accelerator generates result service data based on the to-be-processed service data and writes the result service data into a second queue.

At step 610, the processor core obtains the result service data from the second queue.

Some embodiments of the present disclosure provide a data processing method. The method is applicable to the data processing system. The data processing system includes the processor core and the accelerator. The method includes: writing, by the processor core, the service data processing request into the first queue; reading, by the accelerator, the service data processing request from the first queue, and transmitting data obtaining information to the processor core through the service interface, where the data obtaining information is used for requesting the to-be-processed service data corresponding to the service data processing request from the processor core; obtaining, by the processor core, the to-be-processed service data based on the register identifier in the data obtaining information, and transmitting the to-be-processed service data to the accelerator through the service interface; generating, by the accelerator, the result service data based on the to-be-processed service data, and writing the result service data into the second queue; and obtaining, by the processor core, the result service data from the second queue. According to the method provided in this embodiment of this specification, the accelerator may perform corresponding processing based on the request in the first queue without a need to keep synchronization with the processor core, and may further transmit the request to the processor core to obtain data through the service interface, supporting heterogeneous instructions and only requiring minor changes.

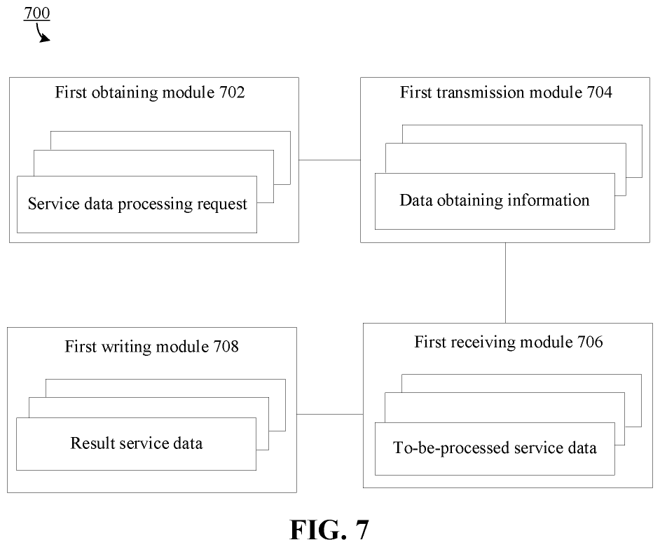

Corresponding to the above method embodiments, the present disclosure further provides a data processing accelerator system. FIG. 7 is a schematic structural diagram of a data processing accelerator system 700, according to some embodiments of the present disclosure. As shown in FIG. 7, the accelerator system 700 is arranged in an accelerator, and includes a first obtaining module 702, a first transmission module 704, a first receiving module 706, and a first writing module 708.

First obtaining module 702 includes circuitry configured to obtain a service data processing request (e.g., command 131 shown in FIG. 1) from a first queue (e.g., first queue 130 shown in FIG. 1).

First transmission module 704 includes circuitry configured to transmit data obtaining information (e.g., request 150 shown in FIG. 1) to a processor core through a service interface, where the data obtaining information is used for requesting to-be-processed service data corresponding to the service data processing request from the processor core.

First receiving module 706 includes circuitry configured to receive the to-be-processed service data (e.g., feedback 160 shown in FIG. 1) transmitted by the processor core, and generate result service data (e.g., result 141 shown in FIG. 1) based on the to-be-processed service data.

First writing module 708 includes circuitry configure to write the result service data (e.g., result 141 shown in FIG. 1) into a second queue (e.g., second queue 140 shown in FIG. 1), so that the processor core obtains the result service data from the second queue.

In some embodiments, first transmission module 704 further includes circuitry configured to: determine whether the to-be-processed service data corresponding to the service data processing request exists in the accelerator; read the to-be-processed service data and perform the step of generating the result service data based on the to-be-processed service data if the to-be-processed service data corresponding to the service data processing request exists in the accelerator; and generate the data obtaining information and transmit the data obtaining information to the processor core through the service interface if the to-be-processed service data corresponding to the service data processing request does not exist in the accelerator.

In some embodiments, first transmission module 704 further includes circuitry configured to: read a register identifier in the service data processing request; search an accelerator register file of the accelerator for a target register corresponding to the register identifier; determine that the to-be-processed service data corresponding to the service data processing request exists when a register status of the target register is valid; and determine that the to-be-processed service data corresponding to the service data processing request does not exist when the register status of the target register is invalid.

In some embodiments, first transmission module 704 further includes circuitry configured to: write a register identifier in the service data processing request into an invalid register queue; and read the register identifier from the invalid register queue and generate the data obtaining information based on the register identifier.

In some embodiments, first receiving module 706 further includes circuitry configured to: receive the to-be-processed service data transmitted by the processor core, and update the accelerator register file based on the register identifier and the to-be-processed service data; and read the to-be-processed service data from the accelerator register file based on the register identifier, and generate the result service data based on the to-be-processed service data.

In some embodiments, the accelerator system 700 further includes: an updating module including circuitry configured to receive data ready information transmitted by the processor core and update the register status of the target register to valid based on the data ready information.

Some embodiments of the present disclosure provide a data processing accelerator system. The accelerator system is arranged in the accelerator, and is configured to: obtain the service data processing request from the first queue; transmit the data obtaining information to the processor core through the service interface, where the data obtaining information is used for requesting the to-be-processed service data corresponding to the service data processing request from the processor core; receive the to-be-processed service data transmitted by the processor core, and generate the result service data based on the to-be-processed service data; and write the result service data into the second queue, so that the processor core obtains the result service data from the second queue. According to the data processing accelerator system provided in present disclosure, the accelerator may perform corresponding processing based on the request in the first queue without a need to keep synchronization with the processor core, and may further transmit the request to the processor core to obtain data through the service interface, supporting heterogeneous instructions and only requiring minor changes.

The above is an exemplary solution of the data processing accelerator system. It should be noted that the technical solutions of the data processing accelerator system belong to the same concept as the technical solutions of the above data processing method. For any details not detailed in the technical solutions of the data processing accelerator system, refer to the descriptions of the technical solutions of the above data processing method.

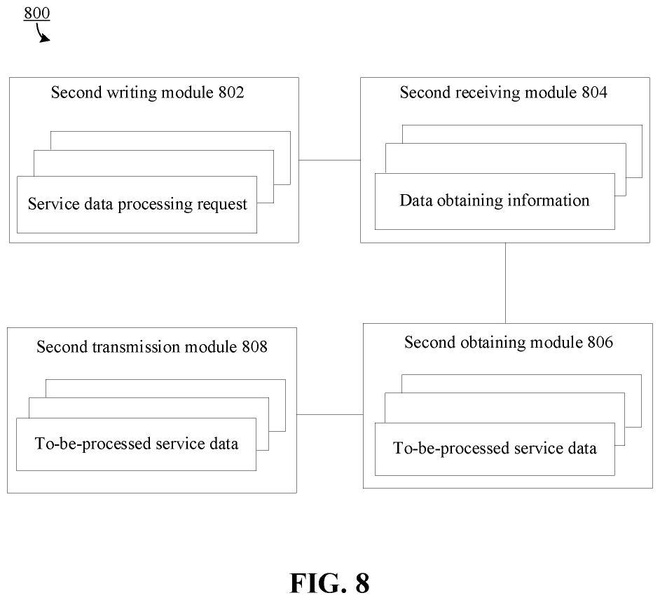

Corresponding to the above method embodiments, the present disclosure further provides a data processing accelerator system. FIG. 8 is a schematic structural diagram of a data processing accelerator system 800, according to some embodiments of the present disclosure. As shown in FIG. 8, the accelerator system 800 is arranged in a processor core, and includes a second writing module 802, a second receiving module 804, a second obtaining module 806, and a second transmission module 808.

Second writing module 802 includes circuitry configured to receive a service data processing request (e.g., command 131 shown in FIG. 1), and write the service data processing request into a first queue (e.g., first queue 130 shown in FIG. 1), so that an accelerator obtains the service data processing request from the first queue.

Second receiving module 804 includes circuitry configured to receive, based on a service interface, data obtaining information (e.g., request 150 shown in FIG. 1) transmitted by the accelerator, where the data obtaining information carries a register identifier.

Second obtaining module 806 includes circuitry configured to obtain to-be-processed service data (e.g., feedback 160 shown in FIG. 1) from a core register file of the processor core based on the register identifier.

Second transmission module 808 includes circuitry configured to transmit the to-be-processed service data to the accelerator.

In some embodiments, the accelerator system further includes: a data reading module including circuitry configured to read result service data (e.g., result 141 shown in FIG. 1) from a second queue (e.g., second queue 140 shown in FIG. 1), where the result service data is generated based on the to-be-processed service data; and a storage module including circuitry configured to update the core register file based on the result service data and the register identifier.

In some embodiments, the accelerator system 800 further includes: a generation module including circuitry configured to generate data ready information based on the register identifier; and a data transmission module including circuitry configured to transmit the data ready information to the accelerator.

In some embodiments, the second obtaining module 806 further includes circuitry configured to: search a register comparison table for register location information corresponding to the register identifier; and search the core register file based on the register location information for the to-be-processed service data corresponding to the register identifier.

Some embodiments of the present disclosure provide a data processing accelerator system. The accelerator system is arranged in the processor core, and is configured to: receive the service data processing request, and write the service data processing request into the first queue, so that the accelerator obtains the service data processing request from the first queue; receive, based on the service interface, the data obtaining information transmitted by the accelerator, where the data obtaining information carries the register identifier; obtain to-be-processed service data from the core register file of the processor core based on the register identifier; and transmit the to-be-processed service data to the accelerator. According to the method provided in this embodiment of this specification, the accelerator may perform corresponding processing based on the request in the first queue without a need to keep synchronization with the processor core, and may further transmit the request to the processor core to obtain data through the service interface, supporting heterogeneous instructions and only requiring minor changes.

The above is an exemplary solution of the data processing accelerator system according to some embodiments of the present disclosure. It should be noted that the technical solutions of the data processing accelerator system belong to the same concept as the technical solutions of the above data processing method. For any details not detailed in the technical solutions of the data processing accelerator system, refer to the descriptions of the technical solutions of the above data processing method.

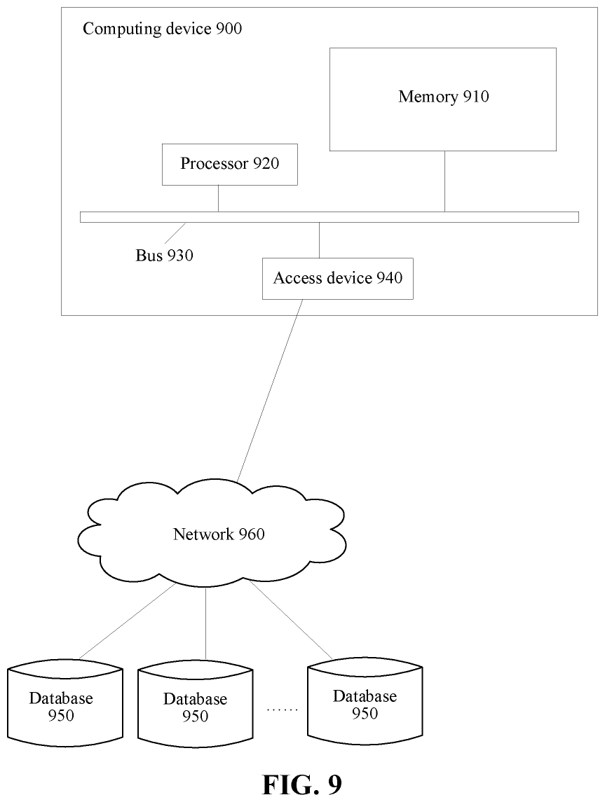

FIG. 9 is a structural block diagram of a computing device 900, according to some embodiments of the present disclosure. Components of the computing device 900 include but are not limited to a memory 910, one or more processors 920 (e.g., including processing system having core 110 and at least one hardware accelerator processor 120), and a database 950. The processor 920 is communicatively coupled to the memory 910 through a bus 930, and the database 950 is configured to store data.

Computing device 900 further includes an access device 940. The access device 940 enables computing device 900 to perform communication through one or more networks 960. Examples of the networks include a public switched telephone network (PSTN), a local area network (LAN), a wide area network (WAN), a personal area network (PAN), or a combination of communication networks such as the Internet. The access device 940 may include one or more of any type of wired or wireless network interfaces (for example, a network interface controller (NIC)), such as an IEEE802.11 wireless local area network (WLAN) wireless interface, a worldwide interoperability for microwave access (Wi-MAX) interface, an Ethernet interface, a universal serial bus (USB) interface, a cellular network interface, a Bluetooth interface, and near field communication (NFC).

In some embodiments, the above components of the computing device 900 and other components not shown in FIG. 9 may be communicatively coupled to each other, for example, through the bus 930. It should be understood that the structural block diagram of the computing device shown in FIG. 9 is merely used for illustration and is not a limitation on the scope of this specification. A person skilled in the art may add other components or replace the components with other components as required.

Computing device 900 may be any type of stationary or mobile computing device, including a mobile computer or a mobile computing device (such as a tablet computer, a personal digital assistant, a laptop computer, a notebook computer, or a netbook), a mobile phone (such as a smartphone), a wearable computing device (such as a smartwatch or smart glasses), or another type of mobile device, or a stationary computing device such as a desktop computer or a personal computer (PC). The computing device 900 may be a stationary or mobile server.

Processor 920 may be a generic or specific electronic device capable of manipulating or processing information. For example, the processor may include any combination of any number of a central processing unit (or “CPU”), a graphics processing unit (or “GPU”), an optical processor, a programmable logic controllers, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), a neural processing unit (NPU), and any type of circuit capable of data processing. In some embodiments, the accelerator can include the GPU, the NPU, among other types.

Processor 920 is configured to execute the following instruction set. The instruction set, when executed by the processor, implements the steps of the above data processing method. The above is an exemplary solution of the computing device in this embodiment. It should be noted that the technical solutions of the computing device belong to the same concept as the technical solutions of the above data processing method. For any details not detailed in the technical solutions of the computing device, refer to the descriptions of the technical solutions of the above data processing method.

Some embodiments of the present disclosure further provide a computer-readable storage medium, storing an instruction set. The instruction set is executable by one or more processors of an accelerator system. The instruction set, when executed by the processor, implements the steps of the above data processing method.

The above is an exemplary solution of the computer-readable storage medium in the present disclosure. It should be noted that the technical solutions of the storage medium belong to the same concept as the technical solutions of the above data processing method. For any details not detailed in the technical solutions of the storage medium, refer to the descriptions of the technical solutions of the above data processing method.

Some embodiments of the present disclosure further provide a computer program. The computer program, when executed on a computer, causes the computer to perform the steps of the above data processing method.

The above is an exemplary solution of the computer program according to some embodiments of the present disclosure. It should be noted that the technical solutions of the computer program belong to the same concept as the technical solutions of the above data processing method. For any details not detailed in the technical solutions of the computer program, refer to the descriptions of the technical solutions of the above data processing method.

The embodiments may further be described using the following clauses:

1. A data processing method, applicable to an accelerator that is communicatively coupled to a processor core, comprising:
obtaining a service data processing request from a first queue from the processor core via a service interface;
obtaining to-be-processed service data corresponding to the service data processing request;
generating result service data based on the to-be-processed service data; and
   writing the result service data into a second queue for providing to the processor core.

2. The method according to clause 1, wherein obtaining the to-be-processed service data corresponding to the service data processing request comprises:
determining whether the to-be-processed service data corresponding to the service data processing request exists in the accelerator;
when the to-be-processed service data corresponding to the service data processing request exists in the accelerator, reading the to-be-processed service data; and
   when the to-be-processed service data corresponding to the service data processing request does not exist in the accelerator, generating data obtaining information and transmitting the data obtaining information to a processor core through a service interface, and receiving the to-be-processed service data transmitted by the processor core.

3. The method according to clause 2, wherein determining whether the to-be-processed service data corresponding to the service data processing request exists in the accelerator comprises:
reading a register identifier in the service data processing request;
searching an accelerator register file of the accelerator for a target register corresponding to the register identifier; and
determining that the to-be-processed service data corresponding to the service data processing request exists when a register status of the target register is valid; or
determining that the to-be-processed service data corresponding to the service data processing request does not exist when the register status of the target register is invalid.

4. The method according to clause 2, wherein generating the data obtaining information comprises:
writing a register identifier in the service data processing request into an invalid register queue;
reading the register identifier from the invalid register queue; and
generating the data obtaining information based on the register identifier.

5. The method according to clause 3, wherein the receiving the to-be-processed service data transmitted by the processor core comprises:
receiving the to-be-processed service data transmitted by the processor core;
updating the accelerator register file based on the register identifier and the to-be-processed service data; and
reading the to-be-processed service data from the accelerator register file based on the register identifier.

6. The method according to clause 3, wherein before receiving the to-be-processed service data transmitted by the processor core, the method further comprises:
receiving data ready information transmitted by the processor core; and
updating the register status of the target register to valid based on the data ready information.

7. A data processing method, applicable to a processor core that is communicatively coupled to an accelerator, comprising:
writing a service data processing request into a first queue accessed by the accelerator; and
reading result service data from a second queue, wherein the result service data is generated by the accelerator based on to-be-processed service data.

8. The method according to clause 7, wherein before receiving the result service data from a second queue, the method further comprises:
receiving, based on a service interface, data obtaining information transmitted by the accelerator, wherein the data obtaining information carries a register identifier;
obtaining the to-be-processed service data from a core register file of the processor core based on the register identifier; and
transmitting the to-be-processed service data to the accelerator.

9. The method according to clause 7, further comprising:
updating the core register file based on the result service data and the register identifier.

10. The method according to clause 8, wherein before obtaining the to-be-processed service data from the core register file of the processor core based on the register identifier, the method further comprises:
generating data ready information based on the register identifier; and
transmitting the data ready information to the accelerator.

11. The method according to clause 8, wherein obtaining the to-be-processed service data from the core register file of the processor core based on the register identifier comprises:
searching a register comparison table for register location information corresponding to the register identifier; and
searching the core register file based on the register location information for the to-be-processed service data corresponding to the register identifier.

12. The method according to clause 7, wherein before writing the service data processing request into the first queue, the method further comprises:
receiving the service data processing request.

13. A data processing method, applicable to a data processing system, wherein the data processing system comprises a processor core and an accelerator, and the method comprises:
writing, by the processor core, a service data processing request into a first queue;
reading, by the accelerator, the service data processing request from the first queue;
generating, by the accelerator, result service data based on the to-be-processed service data, and writing the result service data into a second queue; and
obtaining, by the processor core, the result service data from the second queue.

14. The method according to clause 13, wherein before generating, by the accelerator, the result service data based on the to-be-processed service data, and writing the result service data into a second queue, the method further comprises:
transmitting, by the accelerator, data obtaining information to the processor core through a service interface, wherein the data obtaining information is used for requesting to-be-processed service data corresponding to the service data processing request from the processor core; and
obtaining, by the processor core, the to-be-processed service data based on a register identifier in the data obtaining information and transmitting the to-be-processed service data to the accelerator through the service interface.

15. A data processing accelerator system, arranged in an accelerator, comprising:
a first obtaining module comprising circuitry configured to obtain a service data processing request from a first queue;
a first receiving module comprising circuitry configured to generate result service based on to-be-processed service data; and
a first writing module comprising circuitry configure to write the result service data into a second queue, so that the processor core obtains the result service data from the second queue.

16. The data processing accelerator system according to clause 15, further comprising:
a first transmission module comprising circuitry configured to transmit data obtaining information to a processor core through a service interface, wherein the data obtaining information is used for requesting to-be-processed service data corresponding to the service data processing request from the processor core; and
the first receiving module further comprises circuitry configured to receive the to-be-processed service data transmitted by the processor core.

17. The data processing accelerator system according to clause 16, wherein the first transmission module further comprises a first selection module and a second selection module; wherein the first selection module comprises circuitry configured to:
read a register identifier in the service data processing request;
search an accelerator register file of the accelerator for a target register corresponding to the register identifier; and
determine whether the target register is valid;
when the target register is valid, the first selection module is further configured to:
read the to-be-processed service data; and
generate result service data based on the to-be-processed service data;
when the target register is invalid, the second selection module comprises circuitry configured to:
generate the data obtaining information; and
transmit the data obtaining information to a processor core through a service interface.

18. A data processing accelerator system, arranged in a processor core, comprising:
a second writing module comprising circuitry configured to receive a service data processing request, and write the service data processing request into a first queue, so that an accelerator obtains the service data processing request from the first queue;
a second receiving module comprising circuitry configured to receive, based on a service interface, data obtaining information transmitted by the accelerator, wherein the data obtaining information carries a register identifier;
a second obtaining module comprising circuitry configured to obtain to-be-processed service data from a core register file of the processor core based on the register identifier; and
a second transmission module comprising circuitry configured to transmit the to-be-processed service data to the accelerator.

19. An apparatus, comprising:
a memory configured to store instructions; and
one or more processors configured to execute the instructions to cause the apparatus to perform operations according to any one of clauses 1 to 6 or 7 to 12.

20. A non-transitory computer readable medium that stores a set of instructions that is executable by one or more processors of an apparatus to cause the apparatus to perform operations according to any one of clauses 1 to 6 or 7 to 12.

21. A system, comprising:
a processor core configured to write a service data processing request into a first queue; and
an accelerator communicatively coupled to the processor core, configured to:
   obtain the service data processing request from the first queue;
   obtain to-be-processed service data corresponding to the service data processing request from the processor core via a service interface;
   generate result service data based on the to-be-processed service data; and
   write the result service data into a second queue for providing to the processor core;
wherein the processor core is further configured to:
   read the result service data from the second queue.

22. The system according to clause 21, wherein the accelerator is further configured to:
determine whether the to-be-processed service data corresponding to the service data processing request exists in the accelerator;
when the to-be-processed service data corresponding to the service data processing request exists in the accelerator, read the to-be-processed service data; and
when the to-be-processed service data corresponding to the service data processing request does not exist in the accelerator, generate data obtaining information and transmitting the data obtaining information to the processor core through a service interface;
the processor core is further configured to:
receive, based on a service interface, the data obtaining information transmitted by the accelerator, wherein the data obtaining information carries the register identifier;
obtain the to-be-processed service data from a core register file of the processor core based on the register identifier; and
transmit the to-be-processed service data to the accelerator; and
the accelerator is further configured to receive the to-be-processed service data transmitted by the processor core.

23. The system according to clause 22, wherein the accelerator is further configured to:
read the register identifier in the service data processing request;
search an accelerator register file of the accelerator for a target register corresponding to the register identifier; and
determine that the to-be-processed service data corresponding to the service data processing request exists when a register status of the target register is valid; and
determining that the to-be-processed service data corresponding to the service data processing request does not exist when the register status of the target register is invalid.

24. The system according to clause 23, wherein the accelerator is further configured to:
update the accelerator register file based on the register identifier and the to-be-processed service data; and
   read the to-be-processed service data from the accelerator register file based on the register identifier.

25. The system according to clause 23, wherein the accelerator is further configured to:
write the register identifier in the service data processing request into an invalid register queue;
read the register identifier from the invalid register queue; and
generate the data obtaining information based on the register identifier.

26. The system according to clause 24, wherein the accelerator is further configured to:
receive data ready information transmitted by the processor core; and
update the register status of the target register to valid based on the data ready information.

27. The system according to clause 22, wherein the processor core is further configured to:
update the core register file based on the result service data and the register identifier.

28. The system according to clause 22, wherein the processor core is further configured to:
generate data ready information based on the register identifier; and
transmit the data ready information to the accelerator.

29. The system according to clause 22, wherein the processor core is further configured to:
search a register comparison table for register location information corresponding to the register identifier; and
search the core register file based on the register location information for the to-be-processed service data corresponding to the register identifier.

30. The system according to clause 21, wherein the processor core is further configured to: receive the service data processing request from an upper-level service logic layer.

In some embodiments, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A data processing method, applicable to an accelerator that is communicatively coupled to a processor core, comprising:
obtaining a service data processing request from a first queue;
obtaining to-be-processed service data corresponding to the service data processing request from the processor core via a service interface;
generating result service data based on the to-be-processed service data; and
writing the result service data into a second queue for providing to the processor core.

2. The method according to claim 1, wherein obtaining the to-be-processed service data corresponding to the service data processing request comprises:
determining whether the to-be-processed service data corresponding to the service data processing request exists in the accelerator;
when the to-be-processed service data corresponding to the service data processing request exists in the accelerator, reading the to-be-processed service data; or
when the to-be-processed service data corresponding to the service data processing request does not exist in the accelerator, generating data obtaining information and transmitting the data obtaining information to the processor core through a service interface, and receiving the to-be-processed service data transmitted by the processor core.

3. The method according to claim 2, wherein determining whether the to-be-processed service data corresponding to the service data processing request exists in the accelerator comprises:
reading a register identifier in the service data processing request;
searching an accelerator register file of the accelerator for a target register corresponding to the register identifier; and
determining that the to-be-processed service data corresponding to the service data processing request exists when a register status of the target register is valid; or
determining that the to-be-processed service data corresponding to the service data processing request does not exist when the register status of the target register is invalid.

4. The method according to claim 3, wherein generating the data obtaining information comprises:
writing the register identifier in the service data processing request into an invalid register queue;
reading the register identifier from the invalid register queue; and
generating the data obtaining information based on the register identifier.

5. The method according to claim 3, wherein the receiving the to-be-processed service data transmitted by the processor core comprises:
receiving the to-be-processed service data transmitted by the processor core;
updating the accelerator register file based on the register identifier and the to-be-processed service data; and
reading the to-be-processed service data from the accelerator register file based on the register identifier.

6. The method according to claim 3, wherein before receiving the to-be-processed service data transmitted by the processor core, the method further comprises:
receiving data ready information transmitted by the processor core; and
updating the register status of the target register to valid based on the data ready information.

7. A data processing method, applicable to a processor core that is communicatively coupled to an accelerator, comprising:
writing a service data processing request into a first queue accessed by the accelerator; and
reading result service data from a second queue, wherein the result service data is generated by the accelerator based on to-be-processed service data.

8. The method according to claim 7, wherein before receiving the result service data from a second queue, the method further comprises:
receiving, based on a service interface, data obtaining information transmitted by an accelerator, wherein the data obtaining information carries a register identifier;
obtaining the to-be-processed service data from a core register file of the processor core based on the register identifier; and
transmitting the to-be-processed service data to the accelerator.

9. The method according to claim 8, further comprising:
updating the core register file based on the result service data and the register identifier.

10. The method according to claim 8, wherein before obtaining the to-be-processed service data from the core register file of the processor core based on the register identifier, the method further comprises:
generating data ready information based on the register identifier; and
transmitting the data ready information to the accelerator.

11. The method according to claim 8, wherein obtaining the to-be-processed service data from the core register file of the processor core based on the register identifier comprises:
searching a register comparison table for register location information corresponding to the register identifier; and
searching the core register file based on the register location information for the to-be-processed service data corresponding to the register identifier.

12. The method according to claim 7, wherein before writing the service data processing request into the first queue, the method further comprises:
receiving the service data processing request from an upper-level service logic layer.

13. A system, comprising:
a processor core configured to write a service data processing request into a first queue; and
an accelerator communicatively coupled to the processor core and configured to:
obtain the service data processing request from the first queue;
obtain to-be-processed service data corresponding to the service data processing request from the processor core via a service interface;
generate result service data based on the to-be-processed service data; and
write the result service data into a second queue for providing to the processor core;
wherein the processor core is further configured to:
read the result service data from the second queue.

14. The system according to claim 13, wherein the accelerator is further configured to:
determine whether the to-be-processed service data corresponding to the service data processing request exists in the accelerator;
when the to-be-processed service data corresponding to the service data processing request exists in the accelerator, read the to-be-processed service data; and
when the to-be-processed service data corresponding to the service data processing request does not exist in the accelerator, generate data obtaining information and transmitting the data obtaining information to the processor core through a service interface;
the processor core is further configured to:
receive, based on a service interface, the data obtaining information transmitted by the accelerator, wherein the data obtaining information carries a register identifier;
obtain the to-be-processed service data from a core register file of the processor core based on the register identifier; and
transmit the to-be-processed service data to the accelerator; and
the accelerator is further configured to receive the to-be-processed service data transmitted by the processor core.

15. The system according to claim 14, wherein the accelerator is further configured to:
read the register identifier in the service data processing request;
search an accelerator register file of the accelerator for a target register corresponding to the register identifier; and
determine that the to-be-processed service data corresponding to the service data processing request exists when a register status of the target register is valid; and
determining that the to-be-processed service data corresponding to the service data processing request does not exist when the register status of the target register is invalid.

16. The system according to claim 15, wherein the accelerator is further configured to:
update the accelerator register file based on the register identifier and the to-be-processed service data; and
read the to-be-processed service data from the accelerator register file based on the register identifier.

17. The system according to claim 15, wherein the accelerator is further configured to:
write the register identifier in the service data processing request into an invalid register queue;
read the register identifier from the invalid register queue; and
generate the data obtaining information based on the register identifier.

18. The system according to claim 15, wherein the accelerator is further configured to:
receive data ready information transmitted by the processor core; and
update the register status of the target register to valid based on the data ready information.

19. The system according to claim 14, wherein the processor core is further configured to:
update the core register file based on the result service data and the register identifier.

20. The system according to claim 14, wherein the processor core is further configured to:
generate data ready information based on the register identifier; and
transmit the data ready information to the accelerator.

21. The system according to claim 14, wherein the processor core is further configured to:
search a register comparison table for register location information corresponding to the register identifier, and
search the core register file based on the register location information for the to-be-processed service data corresponding to the register identifier.

22. The system according to claim 13, wherein the processor core is further configured to:
receive the service data processing request from an upper-level service logic layer.
